(19) United States
(12) Patent Application Publication
(10) Pub. No.: US 2026/0164031 A1
(43) Pub. Date: Jun. 11, 2026

(54) TECHNIQUES FOR ENCODING COLOR DATA AND CORRESPONDING ALPHA DATA TO GENERATE A UNIFIED VIDEO BITSTREAM

(71) Applicant: NETFLIX, INC., Los Gatos, CA (US)

(72) Inventors: Weiguo ZHENG, San Jose, CA (US); Po-Jui CHEN, Los Gatos, CA (US); Kevin Andrew COYLE, San Jose, CA (US); Weibo NI, Salt Lake City, UT (US); Michael Aki SCHASSBERGER, San Ramon, CA (US)

(21) Appl. No.: 19/412,728

(22) Filed: Dec. 8, 2025

Related U.S. Application Data
(60) Provisional application No. 63/729,826, filed on Dec. 9, 2024.
(60) Provisional application No. 63/733,956, filed on Dec. 13, 2024.

(51) Int. Cl. H04N 19/136; H04N 19/172; H04N 19/196; H04N 19/86

(52) U.S. Cl. CPC H04N 19/136; H04N 19/172; H04N 19/196; H04N 19/86

(57) ABSTRACT

In various embodiments, a unified encoding pipeline generates a unified video bitstream. The unified encoding pipeline performs serialization operation(s) on a sequence of color frames and a sequence of alpha frames to generate serialized frames. The unified encoding pipeline determines that a first frame included in the serialized frames corresponds to a color frame type. The unified encoding pipeline encodes the first frame to generate an encoded color frame and incorporates the encoded color frame into the unified video bitstream. The unified encoding pipeline determines that a second frame included in the serialized frames corresponds to an alpha frame type. The unified encoding pipeline encodes the second frame to generate an encoded alpha frame and incorporates the encoded alpha frame into the first unified video bitstream.

### CROSS-REFERENCE TO RELATED APPLICATIONS

This application claims priority benefit of the United States Provisional Patent Application titled, “INTEGRATING ALPHA CHANNEL INTO VIDEO CODING,” filed on Dec. 9, 2024, and having Ser. No. 63/729,826. This application also claims priority benefit of the United States Provisional Patent Application titled, “TECHNIQUES FOR INTEGRATING ALPHA CHANNELS INTO VIDEO CODING,” filed on Dec. 13, 2024, and having Ser. No. 63/733,956. The subject matter of these related applications is hereby incorporated herein by reference.

### BACKGROUND

### Field of the Various Embodiments

The various embodiments relate generally to computer science and media encoding and streaming technologies and, more specifically, to techniques for encoding color data and corresponding alpha data to generate a unified video bitstream.

### Description of the Related Art

To support various types of enhanced visual effects implemented with source video content, the source video content oftentimes is structured to include a sequence of color frames and a corresponding sequence of alpha frames. A color frame and a corresponding alpha frame specify, respectively, a visual color and a degree of transparency for each pixel location in the array of pixel locations making up the two frames (i.e., the color frame and the alpha frame). Some examples of enhanced visual effects that alpha frames can enable include, without limitation, composing source video content over different backgrounds, creating see-through regions in source video content, and integrating certain video elements (e.g., logos, text, computer-generated imagery) with source video content.

In some streaming implementations, where this type of source video content is streamed to televisions and other endpoint devices, two different instances of an encoder separately encode the color frames and the alpha frames to generate two different bitstreams—a bitstream of encoded color frames and a bitstream of encoded alpha frames. The two bitstreams are subsequently delivered on-demand to any number of endpoint devices via a content delivery network (CDN). To generate and playback final or “rendered” video content that includes various desired visual effects, a given endpoint device has to execute two different instances of a decoder to independently decode the encoded color frames and the encoded alpha frames included in the two different bitstreams. For each decoded color frame generated from the bitstream of encoded color frames, the endpoint device generates and displays a corresponding rendered frame based on the decoded color frame and a corresponding decoded alpha frame generated from the bitstream of encoded alpha frames.

One drawback of the above approach is that the encoded color frames and encoded alpha frames included in the two different bitstreams received by an endpoint device can be temporarily-misaligned. In particular, because of network instability and other variable transmission conditions, the transmission of two different bitstreams to a given endpoint device can be asynchronous and/or frames can be dropped from one bitstream during transmission but not the other bitstream. Notably, though, accurately computing a rendered frame requires a decoded color frame and a corresponding decoded alpha frame that are temporally aligned. Accordingly, any temporal misalignments between the color frames and alpha frames included across the two different bitstreams can result in the generation of “inaccurate” rendered frames that include transparency-related distortions that can ultimately reduce overall visual quality when playing back the rendered video content. For example, in situations where such “inaccurate” rendered frames are generated, a region of a decoded color frame that is intended to be fully opaque could appear as transparent or partially transparent in a corresponding rendered frame, a region of a decoded color frame that is intended to be fully transparent could end-up occluding an integrated visual element in a corresponding rendered frame, an edge of an object could appear jagged instead of smooth in a rendered frame, or an edge of an object could appear to flicker from rendered frame to rendered frame.

Another drawback of the above approach is that different endpoint devices can have widely varying memory resources and processing capabilities. Accordingly, some endpoint devices may not be able to perform the video processing techniques necessary to generate rendered video content based on two different bitstreams. In this regard, not all endpoint devices are capable of decoding multiple bitstreams in order to generate and display rendered video content that includes transparency-based visual effects. Accordingly, these endpoint devices usually disregard bitstreams that include alpha frames and simply generate and display rendered video content without regard to transparency-based visual effects.

As the foregoing illustrates, what is needed in the art are more effective techniques for streaming video content to generate transparency-based visual effects.

### SUMMARY

One embodiment sets forth a computer-implemented method for generating unified video bitstreams. The method includes performing one or more serialization operations on a sequence of color frames and a sequence of alpha frames to generate a set of serialized frames; determining that a first frame included in the set of serialized frames corresponds to a color frame type; encoding the first frame to generate an encoded color frame; incorporating the encoded color frame into a first unified video bitstream; determining that a second frame included in the set of serialized frames corresponds to an alpha frame type; encoding the second frame to generate an encoded alpha frame; and incorporating the encoded alpha frame into the first unified video bitstream.

At least one technical advantage of the disclosed techniques relative to the prior art is that, with the disclosed techniques, endpoint devices can more accurately compute rendered frames that include transparency-based visual effects. In that regard, a unified video bitstream that includes encoded video frames, encoded alpha frames, and one or more synchronization mechanisms is generated and transmitted to any number of endpoint devices. Each endpoint device can use one of the synchronization mechanisms to compute each rendered frame based on a decoded color frame and a temporally-aligned decoded alpha frame. Another advantage of the disclosed techniques is that, unlike prior art techniques, with the disclosed techniques, an endpoint device does not need to decode multiple different bitstreams in order to generate and display rendered video content that includes transparency-based visual effects. Accordingly, with the disclosed techniques, endpoint devices that were unable to perform the video processing techniques necessary to generate rendered video content with transparency-based visual effects based on multiple different bitstreams can now effectively generate and playback such rendered video content. These technical advantages provide one or more technical advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the video encoding application of FIG. 1, according to various embodiments;

FIG. 3 is a more detailed illustration of the playback pipeline of FIG. 1, according to various embodiments;

FIG. 4 is a flow diagram of method steps for encoding color frames and corresponding alpha frames to generate a unified video bitstream, according to various embodiments; and

FIG. 5 is a flow diagram of method steps for decoding a unified video bitstream to generate rendered video content for playback, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances or versions of like objects are denoted with reference numbers identifying the object and parenthetical numbers identifying the instance where needed.

A typical video streaming service provides access to a wide range of source video content corresponding to different media titles that can be viewed on a range of different endpoint devices. To support various types of enhanced visual effects implemented with source video content, the video streaming service oftentimes structures the source video content to include a sequence of color frames and a corresponding sequence of alpha frames. In some streaming implementations, to efficiently deliver videos to endpoint devices, the video streaming service provider uses two different instances of an encoder to separately encode the sequence of color frames and the sequence of alpha frames to generate, respectively, a bitstream of encoded color frames and a bitstream of encoded alpha frames. The two bitstreams are delivered on-demand to any number of endpoint devices via a CDN. To generate and playback rendered video content that includes various desired visual effects, an endpoint device has to execute two different instances of a decoder to independently decode the encoded color frames and the encoded alpha frames included in the two different bitstreams. For each decoded color frame generated from the bitstream of encoded color frames, the endpoint device generates and displays a corresponding rendered frame based on the decoded color frame and a corresponding decoded alpha frame generated from the bitstream of encoded alpha frames.

One drawback of the above approach is that because of network instability and other variable transmission conditions, the transmission of two different bitstreams to a given endpoint device can be asynchronous and/or frames can be dropped from one bitstream during transmission but not the other bitstream. As a result, the encoded color frames and encoded alpha frames included in the two different bitstreams received by an endpoint device can be temporally misaligned. Any temporal misalignments between the color frames and alpha frames included across the two different bitstreams can result in the generation of “inaccurate” rendered frames that include transparency-related distortions that can ultimately reduce overall visual quality when playing back the rendered video content.

With the disclosed techniques, however, a unified encoding pipeline generates serialized frames based on a sequence of color frames and a sequence of alpha frames. The serialized frames include, without limitation, color frames interleaved with alpha frames and associated “synchronization metadata.” The synchronization metadata accurately describes a one-to-one temporal correspondence between the color frames and the alpha frames. A single instance of an encoder generates a unified video stream based on the serialized frames. The unified video stream includes, without limitation, encoded color frames, encoded alpha frames, and encoded synchronization metadata. The unified video stream is delivered on-demand to any number of endpoint devices via a CDN.

To generate and playback rendered video content that includes various desired transparency-based visual effects, an endpoint device can implement a playback pipeline. The playback pipeline decodes the unified video stream using a single instance of a decoder. The resulting decoded serialized frames include decoded color frames, decoded alpha frames, and decoded synchronization metadata. The playback pipeline uses the decoded synchronization metadata to sequentially organize the decoded color frames and the decoded alpha frames into decoded frame sets. Each decoded frame set includes, without limitation, a decoded color frame and a decoded alpha frame that is temporally aligned with the decoded color frame. The playback pipeline computes and displays a different rendered frame based on each decoded frame set.

At least one technical advantage of the disclosed techniques relative to the prior art is that synchronization metadata included in a unified video stream enables endpoint devices to more accurately compute rendered frames that include transparency-based visual effects. Another advantage of the disclosed techniques is that an endpoint device can use a single instance of a decoder to decode a unified video stream. Accordingly, with the disclosed techniques, endpoint devices that were unable to perform the video processing techniques necessary to generate rendered video content with transparency-based visual effects based on multiple different bitstreams can now effectively generate and playback such rendered video content. These technical advantages provide one or more technical advancements over prior art approaches.

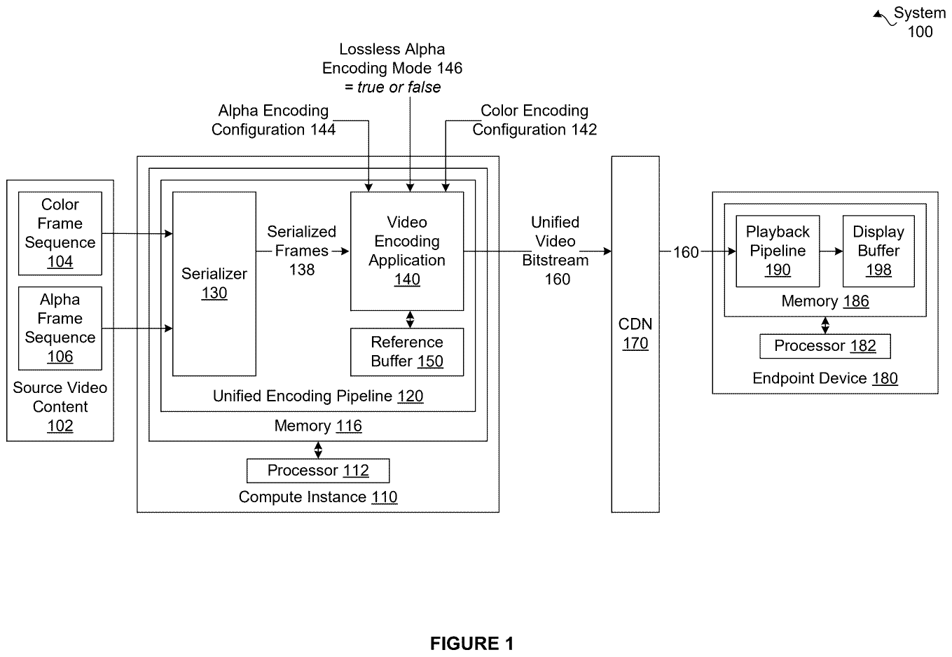

FIG. 1 is a conceptual illustration of a system 100 configured to implement one or more aspects of the various embodiments. As shown, in some embodiments, the system 100 includes, without limitation, a compute instance 110, a content delivery network (CDN) 170, and an endpoint device 180. In some embodiments, the system 100 can include any number of other endpoint devices (not shown). In the same or other embodiments, the system 100 can omit the CDN 170.

Any number of the components of the system 100 can be distributed across multiple geographic locations or implemented in one or more cloud computing environments (e.g., encapsulated shared resources, software, data) in any combination. In some embodiments, the compute instance 110 and/or any number of other compute instances can be implemented in a cloud computing environment, implemented as part of any other distributed computing environment, or implemented in a stand-alone fashion.

As shown, in some embodiments, the compute instance 110 includes, without limitation, a processor 112 and a memory 116. In some embodiments, the compute instance 110 and each of zero or more other compute instances can include any number of processors 112 and any number of memories 116 in any combination. In the same or other embodiments, the compute instance 110 and/or any number of other compute instances can provide any number of multiprocessing environments in any technically feasible fashion.

The processor 112 can be any instruction execution system, apparatus, or device capable of executing instructions. For example, the processor 112 could comprise a central processing unit, a graphics processing unit, a controller, a microcontroller, a state machine, or any combination thereof. The memory 116 of the compute instance 110 stores content, such as software applications and data, for use by the processor 112 of the compute instance 110.

The memory 116 can be one or more of any readily available memory, such as random access memory, read-only memory, floppy disk, hard disk, or any other form of digital storage, local or remote. In some embodiments, a storage (not shown) may supplement or replace the memory 116. The storage can include any number and/or types of external memories that are accessible to the processor 112. For example, and without limitation, the storage can include a Secure Digital Card, an external Flash memory, a portable compact disc read-only memory, an optical storage device, a magnetic storage device, or any suitable combination of the foregoing.

In general, each of the compute instance 110 and zero or more other compute instances is configured to implement one or more software applications. For explanatory purposes only, each software application is described as residing in the memory 116 of the compute instance 110 and executing on the processor 112 of the compute instance 110. However, in some embodiments, the functionality of each software application can be distributed across any number of other software applications that reside in the memories of any number of compute instances or other components of the system 100 and execute on the processors of any number of compute instances or other components of the system 100 in any combination. Further, subsets of the functionality of multiple software applications can be consolidated into a single software application.

In particular, the compute instance 110 is configured to stream source video content 102 to the endpoint device 180 and any number of other endpoint devices (not shown). As shown, the source video content 102 includes, without limitation, a color frame sequence 104 and an alpha frame sequence 106. The color frame sequence 104 is a sequence of color frames and the alpha frame sequence 106 is a corresponding sequence of alpha frames. More specifically, there is a one-to-one correspondence between the color frame sequence 104 and the alpha frame sequence 106.

As used herein, a color frame and a corresponding alpha frame specify, respectively, a visual color and a degree of transparency for each pixel location in an array of pixel locations making up the two frames (i.e., the color frame and the alpha frame) in any technically feasible fashion. In some embodiments, a color frame includes, without limitation, one or more color component values for each pixel location. As used herein, a “color component value” is a value for a color component (e.g., a red component, a blue component, a green component). An alpha frame includes, without limitation, an alpha value for each pixel location, where each alpha value represents a degree of transparency (or opacity) associated with the color component value(s) for the same pixel location that is specified in a corresponding color frame.

As described previously herein, in a conventional approach to streaming this type of source video content to endpoint devices, two different instances of an encoder separately encode the color frames and the alpha frames to generate two different bitstreams. The two different bitstreams are subsequently delivered on-demand to any number of endpoint devices via a CDN. To generate and playback rendered video content that includes any number of desired visual effects, a given endpoint device has to execute two different instances of a decoder to independently decode the encoded color frames and the encoded alpha frames included in the two different bitstreams. For each decoded color frame generated from the bitstream of encoded color frames, the endpoint device generates and displays a corresponding rendered frame based on the decoded color frame and a corresponding decoded alpha frame generated from the bitstream of encoded alpha frames.

One drawback of the above approach is that, because of network instability and other variable transmission conditions, the encoded color frames and encoded alpha frames included in the two different bitstreams received by an endpoint device can be temporarily-misaligned. Any temporal misalignments between the color frames and alpha frames included across the two different bitstreams can result in the generation of “inaccurate” rendered frames that include transparency-related distortions that can ultimately reduce overall visual quality when playing back the rendered video content.

Another drawback of the above approach is that different endpoint devices can have widely varying memory resources and processing capabilities. In particular, not all endpoint devices are capable of decoding multiple bitstreams in order to generate and display rendered video content that includes transparency-based visual effects. Accordingly, these endpoint devices usually disregard bitstreams that include alpha frames and simply generate and display rendered video content without regard to transparency-based visual effects.

### Streaming Video Content That Includes Color Frames and Corresponding Alpha Frames Using a Unified Video Bitstream

To address the above problems, the compute instance 110 is configured to generate a unified video bitstream 160 that includes, without limitation, encoded color frames, encoded alpha frames, and one or more synchronization mechanisms. The unified video bitstream 160 is transmitted to the endpoint device 180 and any number of other endpoint devices (not shown) via the CDN 170. The endpoint device 180 uses one of the synchronization mechanisms(s) to compute rendered frames based on decoded color frames and temporally-aligned decoded alpha frames.

For explanatory purposes, the functionality of the system 100 is described below in the context of generating the unified video bitstream 160 based on the source video content 102 and delivering the unified video bitstream 160 on-demand to the endpoint device 180 via the CDN 170. Note, however, that the techniques described herein are illustrative rather than restrictive. Many modifications and variations will be apparent to those of ordinary skill in the art without departing from the scope and spirit of the described embodiments and techniques.

In particular, in some embodiments, the techniques described herein can be modified to transmit the unified video bitstream 160 to the endpoint device and any number of other endpoint devices in any technically feasible fashion. Each of the endpoint devices can use one of the synchronization mechanisms(s) included in the unified video bitstream 160 to compute rendered frames based on decoded color frames and temporally-aligned decoded alpha frames. In the same or other embodiments, the techniques described herein can be modified to generate any number of unified video bitstreams based on the source video content 102, where each unified video bitstream is associated with a different combination of bitrate and resolution. In some embodiments, the techniques described herein can be modified and applied to streaming any amount and/or types of color data and corresponding alpha data or other transparency data to any number and/or types of endpoint devices.

Advantageously, relative to the prior art, the endpoint device 180 and any number of other endpoint devices can more accurately compute rendered frames that include transparency-based visual effects when streaming the source video content 102. Further, with the disclosed techniques, an endpoint device does not need to decode multiple different bitstreams in order to generate and display rendered video content that includes transparency-based visual effects.

As shown, in some embodiments, a unified encoding pipeline 120 resides in the memory 116 of the compute instance 110 and executes on the processor 112 of the compute instance 110. The unified encoding pipeline 120 incrementally generates the unified video bitstream 160 based on the source video content 102 and delivers the unified video bitstream 160 on-demand to the endpoint device 180 via the CDN 170. More precisely, the unified encoding pipeline 120 generates the unified video bitstream 160 based on the source video content 102, a color encoding configuration 142, an alpha encoding configuration 144, and a lossless alpha encoding mode 146. As shown, in some embodiments, the unified encoding pipeline 120 includes, without limitation, a serializer 130, a video encoding application 140, and a reference buffer 150.

As shown, the serializer 130 generates serialized frames 138 based on the color frame sequence 104 included in the source video content 102 and the alpha frame sequence 106 included in the source video content 102. In operation, if a first bit depth associated with the alpha frame sequence 106 is not equal to a second bit depth associated with the color frame sequence 104, then the serializer 130 converts the alpha frame sequence 106 from the first bit depth to the second bit depth to generate an “input” alpha frame sequence (not shown). Otherwise, the serializer 130 sets the input alpha frame sequence equal to the alpha frame sequence 106.

The serializer 130 performs any number and/or types of serialization operations on the color frame sequence 104 and the input alpha frame sequence to generate the serialized frames 138. As used herein a “serialization operation” refers to any type of operation that is executed when performing serialization, where serialization is a process of converting one or more data objects into a sequence of bits, bytes, or other objects that includes enough information to reconstruct the original data objects.

In particular, the serializer 130 performs one or more serialization operations on the color frame sequence 104 and the input alpha frame sequence to generate the serialized frames 138 that include enough information to accurately reconstruct the color frame sequence 104 and the input alpha frame sequence. Because there is a one-to-one correspondence between the color frame sequence 104 and the alpha frame sequence 106, there is a one-to-one correspondence between the color frame sequence 104 and the input alpha frame sequence. Accordingly, the serialized frames 138 include each of the color frames included in the color frame sequence 104, each of the alpha frames included in the input alpha frame sequence, one or more classification mechanisms, and one or more synchronization mechanisms.

The classification mechanism(s) classify each frame included in the serialized frames 138 as corresponding to either a color frame type or an alpha frame type. As used herein, a frame that corresponds to a color frame type is also referred to herein as a “color frame.” And a frame that corresponds to an alpha frame type is also referred to herein as an “alpha frame.” The synchronization mechanism(s) ensure that the one-to-one correspondence between the color frame sequence 104 and the input alpha frame sequence can be recovered when reconstructing the color frame sequence 104 and the input alpha frame sequence.

The serializer 130 can include any number and/or types of classification mechanisms and synchronization mechanisms in the serialized frames 138. For instance in some embodiments, the serializer 130 uses frame numbers and/or other metadata associated with each of the serialized frames 138 to indicate whether each frame corresponds to a color frame type or an alpha frame type and to establish a one-to-one correspondence between the color frames and the alpha frames included in the serialized frames 138.

In some embodiments, the serializer 130 interleaves the color frame sequence 104 with the input alpha frame sequence when generating the serialized frames 138. As the serializer 130 generates the serialized frames 138, the serializer 130 generates frame numbers and/or other metadata data that indicate whether each frame included in the serialized frames 138 corresponds to the color frame type or the alpha frame type and define a one-to-one correspondence between the color frames included in the serialized frames 138 and the alpha frames included in the serialized frames 138.

In some embodiments, the serializer 130 uses frame numbers to indicate the frame types of the frames included in the serialized frames 138 and/or and to define a one-to-one correspondence between the color frames included in the serialized frames 138 and the alpha frames included in the serialized frames 138. The serializer 130 can include the frame number assignments in the serialized frames 138 in any technically feasible fashion.

In some embodiments, when the serializer 130 copies a color frame from the color frame sequence 104 to the serialized frames 138, the serializer 130 assigns a frame number that indicates the color frame type to the copy of the color frame included in the serialized frames 138. When the serializer 130 copies an alpha frame from the input alpha frame sequence to the serialized frames 138, the serializer 130 assigns frame number that indicates the alpha frame type to the copy of the alpha frame included in the serialized frames 138. The serializer 130 can indicate frame types via frame numbers in any technically feasible fashion. For instance, in some embodiments, the serializer 130 assigns frame numbers having one parity to color frames included in the serialized frames 138 and frame numbers having the opposite parity to alpha frames included in the serialized frames 138.

In some embodiments, when the serializer 130 copies a color frame from the color frame sequence 104 to the serialized frames 138 and copies a corresponding alpha frame from the alpha frame sequence to the serialized frames 138, the serializer 130 assigns consecutive frame numbers to the copies of the color frame and the alpha frame included in the serialized frames 138. For instance, in some embodiments, the frame number assigned by the serializer 130 to an alpha frame is an integer that is one greater than the frame number assigned by the serializer 130 to a corresponding color frame. The frame numbers can subsequently be evaluated to determine a one-to-one correspondence between the color frames included in the serialized frames 138 and the alpha frames included in the serialized frames 138.

In some embodiments, the serializer 130 uses metadata to explicitly indicate the frame types of the frames included in the serialized frames 138 and/or and to define a one-to-one correspondence between the color frames included in the serialized frames 138 and the alpha frames included in the serialized frames 138. The serializer 130 can include metadata in the serialized frames 138 in any technically feasible fashion.

In some embodiments, when the serializer 130 copies a color frame from the color frame sequence 104 to the serialized frames 138, the serializer 130 generates metadata explicitly indicating that the copy of the color frame included in the serialized frames 138 corresponds to the color frame type. When the serializer 130 copies an alpha frame from the input alpha frame sequence to the serialized frames 138, the serializer 130 generates metadata explicitly indicating that the copy of the alpha frame included in the serialized frames 138 corresponds to the alpha frame type. The serializer 130 can include metadata indicating frame type in the serialized frames 138 in any technically feasible fashion.

In some embodiments, when the serializer 130 copies a color frame from the color frame sequence 104 to the serialized frames 138 and copies a corresponding color frame from the alpha frame sequence to the serialized frames 138, the serializer 130 generates metadata indicating that the copy of the alpha frame included in the serialized frames 138 corresponds to the copy of the color frame in included in the serialized frames 138.

In some embodiments, the color frame sequence 104 includes timestamps and when the serializer 130 copies a color frame from the color frame sequence 104 to the serialized frames 138, the serializer 130 assigns the timestamp from the color frame to the copy of the color frame included in the serialized frames 138. When the serializer 130 copies an alpha frame from the input alpha frame sequence to the serialized frames 138, the serializer computes and assigns an interpolated timestamp to the copy of the alpha frame included in the serialized frames 138. More precisely, to compute the interpolated timestamp for an alpha frame included in the serialized frames 138, the serializer 130 interpolates between two timestamps associated with a corresponding color frame and a color frame immediately following the corresponding color frame within the color frame sequence 104.

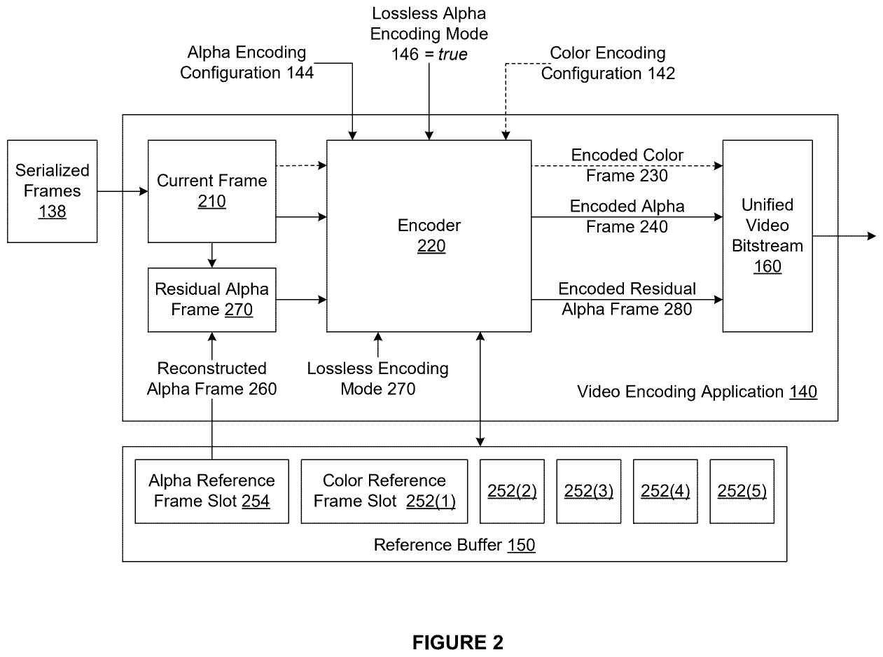

As shown, the video encoding application 140 generates the unified video bitstream 160 based on the serialized frames 138, the color encoding configuration 142, the alpha encoding configuration 144, a lossless alpha encoding mode 146, and the reference buffer 150. As described in greater detail below in conjunction with FIG. 2, the video encoding application 140 sequentially encodes each frame included in the serialized frames 138 and any associated metadata to generate the unified video bitstream 160. As used herein, “encoding a frame” included in the serialized frames 138 refers to encoding the frame and any associated metadata.

The lossless alpha encoding mode 146 can be true or false. The lossless alpha encoding mode 146 can be determined in any technically feasible fashion. For instance, in some embodiments, the lossless alpha encoding mode 146 defaults to false unless the lossless alpha encoding mode 146 is set to true via a user interface. If the lossless alpha encoding mode 146 is false, then the unified video bitstream 160 includes, without limitation, encoded video frames, encoded alpha frames, and at least one synchronization mechanism (e.g., encoded frame numbers, encoded metadata).

If, however, the lossless alpha encoding mode 146 is true, then the video encoding application 140 performs lossless encoding of residual alpha frames to generate encoded residual alpha frames or encoded residual alpha metadata. The encoded residual alpha frames or the encoded residual alpha metadata can increase the accuracy with which endpoint devices (e.g., the endpoint device 180) can reconstruct the input alpha frame sequence. Notably, if the lossless alpha encoding mode 146 is true, then the unified video bitstream 160 includes, without limitation, encoded video frames, encoded alpha frames, encoded residual alpha frames or encoded residual alpha metadata, and at least one synchronization mechanism.

As persons skilled in the art will recognize, the reference buffer 150 includes a finite number of slots, where each slot can store a reconstructed frame that can be used to generate subsequent encoded frames. Importantly, at any given point-in-time, the video encoding application 140 is configured to store at most a first reference frame count of reconstructed color frames and at most a second reference frame count of reconstructed alpha frames in the reference buffer 150, where the second reference frame count is lower than the first reference frame count. The sum of the first reference frame count and the second reference frame count is equal to the number of slots included in the reference buffer 150.

The video encoding application 140 can determine the first reference frame count and the second reference frame count in any technically feasible fashion. For instance, in some embodiments, the second reference frame count is specified via a user interface, and the video encoding application 140 subtracts the second reference frame count from the number of slots included in the reference buffer 150 to determine the first reference frame count.

The video encoding application 140 encodes frames that are included in the serialized frames 138 and correspond to the color frame type based on the color encoding configuration 142 and the first reference frame count. By contrast, the video encoding application 140 encodes frames that are included in the serialized frames 138 and correspond to the alpha frame type based on the alpha encoding configuration 144 and the second reference frame count. Importantly, the first reference frame count, the second reference frame count, the color encoding configuration 142, and the alpha encoding configuration 144 are designed to increase the overall encoding efficiency of the video encoding application 140.

In that regard, because the complexity of alpha frames is usually lower than the complexity of color frames, increasing the number of reference frames used when encoding color frames typically results in a higher improvement in overall encoding efficiency than increasing the number of reference frames used when encoding alpha frames. Therefore, to increase overall encoding efficiency, the video encoding application 140 is configured to use more reference frames when encoding color frames than when encoding alpha frames.

The color encoding configuration 142 and the alpha encoding configuration 144 can specify values for any number and/or types of encoding parameters and/or encoding options. Notably, the alpha encoding configuration 144 can include any number and/or types of modifications relative to the color encoding configuration 142 to increase compression efficiency and/or encoding precision for alpha frames. In particular, the color encoding configuration 142 and the alpha encoding configuration 144 can specify different values for a quantization parameter and any number and/or types of filtering options.

To increase the accuracy of transparency information when endpoint devices (e.g., the endpoint device 180) generate rendered frames based on the unified video bitstream 160, the alpha encoding configuration 144 typically specifies a lower value for a quantization parameter relative to a value for the quantization parameter that is specified in the color encoding configuration 142. Accordingly, a first quantization parameter value that the video encoding application 140 uses to encode color frames is greater than a second quantization parameter value that the video encoding application 140 uses to encode alpha frames. In some embodiments, because alpha frames often include sharp edges, the alpha encoding configuration 144 specifies that one or more in-loop filters (e.g., a smoothing filter, a deblocking filter) are to be disabled. In such embodiments, the video encoding application 140 therefore disables one or more in-loop filters when encoding alpha frames.

To encode a “current” frame (not shown) included in the serialized frames 138, the video encoding application 140 determines whether the current frame corresponds to the color frame type or the alpha frame type. The video encoding application 140 can evaluate any amount and/or types of metadata and/or a frame number associated with the current frame to determine whether the current frame corresponds to the color frame type or the alpha frame type.

If the video encoding application 140 determines that the current frame corresponds to the color frame type, then the video encoding application 140 encodes the current frame based on the color encoding configuration 142 and the first reference frame count to generate an encoded color frame (not shown). The video encoding application 140 incorporates the encoded color frame into the unified video bitstream 160.

If, however, the video encoding application 140 determines that the current frame corresponds to the alpha frame type, then the video encoding application 140 encodes the current frame based on the alpha encoding configuration 144 and the second reference frame count to generate an encoded alpha frame (not shown). The video encoding application 140 incorporates the encoded alpha frame into the unified video bitstream 160.

Further, if the lossless alpha encoding mode is true and the current frame corresponds to an alpha frame type, then the video encoding application 140 computes a residual alpha frame and optionally generates any amount of associated metadata based on the encoded alpha frame and the current frame. For instance, in some embodiments, the video encoding application 140 generates a frame number and/or other metadata that collectively indicate that the residual alpha frame corresponds to a residual alpha frame type and to the current frame. The video encoding application 140 performs one or more encoding operations on the residual alpha frame to generate an encoded residual alpha frame or encoded residual alpha metadata. The video encoding application 140 incorporates the encoded residual alpha frame or encoded residual alpha metadata into the unified video bitstream 160.

As shown, the unified encoding pipeline 120 transmits the unified video bitstream 160 to the CDN 170. The CDN 170 stores and transmits or “delivers” the unified video bitstream 160 and any number of other bitstreams (not shown) to the endpoint device 180 and any number of other endpoint devices (not shown).

The endpoint device 180 can be any type of device that includes at least one processor and one memory and is capable of generating, decoding, and playing back video bitstreams. Some examples of endpoint devices include, without limitation, desktop computers, laptops, smartphones, smart televisions, game consoles, tablets, and set-top boxes.

As shown, in some embodiments, the endpoint device 180 includes, without limitation, a processor 182 and a memory 186. The processor 182 can be any instruction execution system, apparatus, or device capable of executing instructions. The memory 186 stores content, such as software applications and data, for use by the processor 182. The memory 186 can be one or more of any readily available memory, such as random access memory, read-only memory, floppy disk, hard disk, or any other form of digital storage, local or remote. In some embodiments, a storage (not shown) may supplement or replace the memory 186. The storage can include any number and/or types of external memories that are accessible to the processor 182. In general, the endpoint device 180 is configured to implement one or more software applications.

As shown, in some embodiments, a playback pipeline 190 resides in the memory 186 and executes on the processor 182. The playback pipeline 190 requests and receives, from the CDN 170, the unified video bitstream 160. The playback pipeline 190 generates final or “rendered” video content that includes various desired visual effects based on the unified video bitstream 160. As the playback pipeline 190 generates each rendered frame in the rendered video content, the playback pipeline 190 stores the rendered frame in a display buffer 198. In some embodiments, the display buffer 198 is a first-in, first-out (FIFO) buffer that can store at least one rendered frame at any given point-in-time. The endpoint device 180 retrieves rendered frames from the display buffer 198 and displays the retrieved rendered frames to playback the rendered video content that includes any number of desired visual effects.

As described in greater detail below in conjunction with FIG. 2, the playback pipeline 190 performs one or more decoding operations on the unified video bitstream 160 to generate decoded serialized frames (not shown) that include any amount and/or types of associated decoded metadata (e.g., frame numbers, frame type metadata, frame correspondence metadata). For explanatory purposes, if a decoded frame corresponds to a color frame type, then the decoded frame is also referred to herein as a “decoded color frame.” if a decoded frame corresponds to an alpha frame type, then the decoded frame is also referred to herein as a “decoded alpha frame.” If a decoded frame corresponds to an alpha residual frame type, then the decoded frame is also referred to herein as a “decoded alpha residual frame.”

If the decoded serialized frames include any decoded alpha residual frames and the playback pipeline 190 is capable of processing decoded alpha residual frames, then a lossless alpha decoding mode (not shown) is true. Otherwise, if the decoded serialized frames include any decoded alpha residual metadata and the playback pipeline 190 is capable of processing decoded alpha residual metadata, then the lossless alpha decoding mode is true. Otherwise, the lossless alpha decoding mode is false. Advantageously, endpoint devices that are not capable of reconstructing alpha frames in a lossless fashion can simply reconstruct alpha frames without the extra precision provided by decoded alpha residual frames or decoded alpha residual metadata.

The playback pipeline 190 sequentially generates decoded frame sets (not shown in FIG. 1) based on the decoded serialized frames (including any associated decoded metadata). Each decoded frame set includes, without limitation, a decoded color frame, a temporally-aligned decoded alpha frame, and optionally a temporally-aligned decoded alpha residual frame or temporally-aligned decoded alpha residual metadata. The playback pipeline 190 can evaluate any amount and/or types of decoded metadata associated with the decoded serialized frames to determine the frame type of each of the decoded frames included in the decoded serialized frames and to establish temporal correspondences between the decoded frames. More precisely, for each decoded color frame, the playback pipeline 190 determines a corresponding alpha frame and optionally either a corresponding alpha residual frame or corresponding alpha residual metadata based on any amount and/or types of associated decoded metadata.

The playback pipeline 190 generates a different rendered frame based on each decoded frame set. If the lossless alpha decoding mode is true, then the playback pipeline 190 computes a restored alpha frame (not shown in FIG. 1) based on the decoded alpha frame and either the decoded residual alpha frame or the decoded alpha residual metadata. The playback pipeline 190 computes a rendered frame (not shown in FIG. 1) that can include any number and/or types of transparency-based visual effects based on the decoded color frame and the restored alpha frame. The playback pipeline 190 stores the rendered frame in the display buffer 198 for subsequent playback.

If, however, the lossless alpha decoding mode is false, then the playback pipeline 190 computes a rendered frame that can include any number and/or types of transparency-based visual effects based on the decoded color frame and the decoded alpha frame. The playback pipeline 190 stores the rendered frame in the display buffer 198 for subsequent playback.

Note that the techniques described herein are illustrative rather than restrictive and can be altered without departing from the broader spirit and scope of the invention. Many modifications and variations on the functionality of the unified encoding pipeline 120, the serializer 130, the video encoding application 140, the CDN 170, the endpoint device 180, and the playback pipeline 190 as described herein will be apparent to those of ordinary skill in the art without departing from the scope and spirit of the described embodiments.

Many modifications and variations on the storage and delivery of the unified video bitstream 160 as described herein will be apparent to those of ordinary skill in the art without departing from the scope and spirit of the described embodiments. For instance, in some embodiments, the CDN 170 is replaced by any amounts and/or types of storage and/or delivery networks, and the techniques described herein are modified accordingly. In the same or other embodiments, any types of portions (e.g., segments, layers) of the unified video bitstream 160, or any combination thereof are stored and delivered to any number and/or types of devices in any technically feasible fashion, and the techniques implemented by the playback pipeline 190 are modified accordingly.

It will be appreciated that the system 100 shown herein is illustrative and that variations and modifications are possible. For example, the functionality provided by the unified encoding pipeline 120, the serializer 130, the video encoding application 140, and the playback pipeline 190 as described herein can be integrated into or distributed across any number of software applications (including one), and any number of components of the system 100. Further, the connection topology between the various units in FIG. 1 can be modified as desired.

### Generating a Unified Video Bitstream Based on Color Frames and Corresponding Alpha Frames

FIG. 2 is a more detailed illustration of the video encoding application 140 of FIG. 1, according to various embodiments. As described previously herein in conjunction with FIG. 1, the video encoding application 140 generates the unified video bitstream 160 based on the serialized frames 138, the color encoding configuration 142, the alpha encoding configuration 144, the lossless alpha encoding mode 146, and the reference buffer 150.

As described previously herein in conjunction with FIG. 1, at any given point-in-time, the video encoding application 140 is configured to store at most a first reference frame count of reconstructed color frames and at most a second reference frame count of reconstructed alpha frames in the reference buffer 150, where the second reference frame count is lower than the first reference frame count. For explanatory purposes, the functionality of the video encoding application 140 is depicted in and described in conjunction with FIG. 2 in the context of the first reference count of five and the second reference count of one. Accordingly, at any given point-in-time, the video encoding application 140 stores at most five reconstructed color frames and at most one reconstructed alpha frame in the reference buffer 150.

As shown, the reference buffer 150 includes, without limitation, a color reference frame slot 252(1)—a color reference frame slot 242(5) and an alpha reference frame slot 254. For explanatory purposes, the color reference frame slot 252(1)—the color reference frame slot 252(5) are also referred to herein collectively as “color reference frame slots 252” and individually as a “color reference frame slot 252.”

In some other embodiments, the first reference count and/or the second reference count can vary from what is depicted in FIG. 2 and therefore the total number of slots included in the reference buffer, the total number of color reference frame slots, the total number of alpha reference frame slots, or any combination thereof can vary from what is depicted in FIG. 2. The techniques described herein are modified accordingly.

The functionality of the video encoding application 140 is further depicted in and described in conjunction with FIG. 2 in the context of generating, and incorporating into the unified video bitstream 160, encoded residual alpha frames based on the lossless alpha encoding mode 146 of true. As described previously herein, in some other embodiments, the video encoding application 140 generates, and incorporates into the unified video bitstream 160, encoded residual alpha metadata instead of encoded residual alpha frames based on the lossless alpha encoding mode 146 of true, and the techniques described herein are modified accordingly. In yet other embodiments, the lossless alpha encoding mode 146 is false, the video encoding application 140 generates neither encoded residual alpha frames nor encoded residual alpha metadata, and the techniques described herein are modified accordingly.

As shown, the video encoding application 140 includes, without limitation, a current frame 210, an encoder 220, and a residual alpha frame 270. The video encoding application 140 sequentially sets the current frame 210 equal to each frame included in the serialized frames 138 and executes an encoding process on the current frame 210. To execute the encoding process on the current frame 210, the video encoding application 140 determines whether the current frame 210 corresponds to the color frame type or the alpha frame type. The video encoding application 140 can evaluate any amount and/or types of metadata (e.g., a frame number) associated with the current frame 210 to determine whether the current frame 210 corresponds to the color frame type or the alpha frame type. The video encoding application 140 then performs one or more encoding operations on the current frame 210 based on the corresponding frame type.

For explanatory purposes, FIG. 2 depicts encoding operations that the video encoding application 140 performs when the current frame 210 corresponds to the color frame type via dashed arrows. FIG. 2 depicts encoding operations that the video encoding application 140 performs when the current frame 210 corresponds to the alpha frame type via solid arrows.

As depicted via dashed arrows, if the current frame 210 corresponds to the color frame type, the video encoding application 140 configures the encoder 220 to encode the current frame 210 (and associated metadata) based on the color encoding configuration 142 and the color reference frame slots 252. The color encoding configuration 142 was described previously herein in conjunction with FIG. 1. In response, the encoder 220 generates an encoded color frame 230. The video encoding application 140 incorporates the encoded color frame 230 into the unified video bitstream 160.

As depicted with solid arrows, if the video encoding application 140 determines that the current frame 210 corresponds to the alpha frame type, then the video encoding application 140 configures the encoder 220 to encode the current frame 210 (and associated metadata) based on the alpha encoding configuration 144 and the alpha reference frame slot 254. The alpha encoding configuration 144 was described previously herein in conjunction with FIG. 1. In response, the encoder 220 generates an encoded alpha frame 240. The video encoding application 140 incorporates the encoded alpha frame 240 into the unified video bitstream 160.

After generating the encoded alpha frame 240, the encoder 220 generates a reconstructed alpha frame 260 based on the encoded alpha frame 240. The reconstructed alpha frame 260 is a reconstructed version of the current frame 210. The encoder 220 stores the reconstructed alpha frame 260 in the alpha reference frame slot 254 for use in generating subsequent encoded frames.

Because the lossless alpha encoding mode 146 is true and the current frame 210 corresponds to the alpha frame type, the video encoding application 140 generates a residual alpha frame 270 based on the current frame 210 and the reconstructed alpha frame 260. More specifically, the video encoding application 140 sets the residual alpha frame 270 equal to a pixel-wise difference between original alpha values included in the current frame 210 and reconstructed alpha values included in the reconstructed alpha frame 260. The computation for the residual alpha frame 270 can be expressed as: the residual alpha frame 270 =the current frame 210—the reconstructed alpha frame 260. The video encoding application 140 generates any amount and/or types of metadata to classify the residual alpha frame 270 as corresponding to a residual alpha frame type and to the current frame 210.

The video encoding application 140 configures the encoder 220 to encode the residual alpha frame 270 (and the associated metadata) based on a lossless encoding mode. In response, the encoder 220 performs one or more lossless encoding operations on the current frame 210 to generate an encoded residual alpha frame 280. The video encoding application 140 incorporates the encoded residual alpha frame 280 into the unified video bitstream 160.

Note that the techniques described herein are illustrative rather than restrictive and can be altered without departing from the broader spirit and scope of the invention. Many modifications and variations on the functionality of the video encoding application 140, the encoder 220, and the reference buffer 150 as described herein will be apparent to those of ordinary skill in the art without departing from the scope and spirit of the described embodiments.

In some embodiments, the video encoding application 140 can add, remove, modify, or any combination thereof, any amount and/or types of frame numbers and/or other metadata associated with the serialized frames 138 prior to and/or during encoding. For instance, prior to encoding, the video encoding application 140 can assign or re-assign frame numbers to each current frame and each residual alpha frame. The frame numbers indicate the sequence in which the frames are encoded and the resulting encoding frames are incorporated into the unified video bitstream 160. The playback pipeline 190 can evaluate (e.g., using a modulo 3 operator) a decoded frame number associated with a decoded frame derived from the unified video bitstream 160 to determine whether the decoded frame corresponds to the color frame type, the alpha frame type, or the alpha residual frame type.

Advantageously, with the disclosed techniques, the video encoding application 140 can generate a single bitstream (e.g., the unified video bitstream 160) that includes encoded color frames, encoded alpha frames, optionally encoded alpha residual alpha frames or encoded alpha residual metadata, and encoded metadata that enables proper synchronization of decoded versions of the frames. For each decoded color frame, the encoded metadata enables endpoint devices to determine a temporally-aligned decoded alpha frame and optionally a temporally-aligned decoded residual alpha frame or temporally-aligned decoded residual alpha metadata. Relative to prior art techniques, endpoint devices can therefore more accurately compute residual frames that include transparency-based visual effects. Furthermore, unlike some prior art techniques, the video encoding application 140 uses a single instance of an encoder to encode color frames, alpha frames, and optionally residual alpha frames or residual alpha metadata. Accordingly, the computational complexity associated with generating encoded data that enables endpoint devices to generate rendered video content with transparency-based visual effects can be substantially reduced relative to prior-art techniques that use multiple instances of an encoder to separately encode color frames and alpha frames.

### Generating Rendered Video Content That Includes Transparency-Based Visual Effects Based on a Unified Video Bitstream

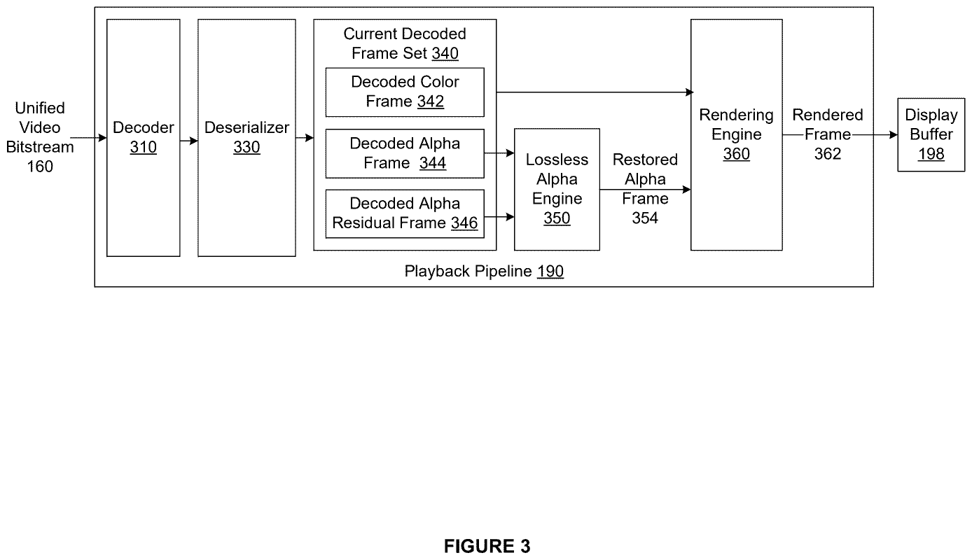

FIG. 3 is a more detailed illustration of the playback pipeline 190 of FIG. 1, according to various embodiments. As described previously herein in conjunction with FIG. 1, the playback pipeline 190 generates, and stores in the display buffer 198, a sequence of rendered frames based on the unified video bitstream 160. For explanatory purposes, the functionality of the playback pipeline 190 is depicted and described in conjunction with FIG. 3 in the context of generating the sequence of rendered frames based on the unified video bitstream 160 described previously herein in conjunction with FIG. 2 using a lossless alpha decoding mode (not shown) of true. More specifically, the unified video bitstream 160 includes, without limitation, encoded color frames, encoded alpha frames, encoded alpha residual frames, and any amount and/or types of encoded metadata that provide at least one synchronization mechanism. Further, the playback pipeline 190 is capable of processing encoded alpha residual frames and therefore operates in a lossless alpha decoding mode of true.

As described previously herein, in some other embodiments, the playback pipeline 190 operates in the lossless alpha decode mode of true and the unified video bitstream 160 includes, without limitation, encoded color frames, encoded alpha frames, encoded alpha residual metadata, and any amount and/or types of encoded metadata that provide at least one synchronization mechanism. In such embodiments, the techniques described herein are modified accordingly. In the same or other embodiments, the playback pipeline 190 operates in a lossless alpha decoding mode of false, and the techniques described herein are modified accordingly.

As shown, the playback pipeline 190 includes, without limitation, a decoder 310, a deserializer 330, a current decoded frame set 340, a lossless alpha engine 350, and a rendering engine 360. Referring back to FIG. 1, the playback pipeline 190 requests and receives, from the CDN 170, the unified video bitstream 160.

The decoder 310 performs one or more decoding operations on the unified video bitstream 160 to generate decoded serialized frames (not shown) that include any amount and/or types of associated decoded metadata (e.g., frame numbers, frame type metadata, frame correspondence metadata). The deserializer 330 sequentially determines new decoded frame sets based on the decoded serialized frames. More specifically, for each decoded color frame included in the decoded serialized frames, the deserializer 330 generates a new decoded frame set that includes, without limitation, the decoded color frame, a corresponding decoded alpha frame, and a corresponding decoded alpha residual frame. The deserializer 330 can perform any number and/or types of deserialization operations on the decoded serialized frames to generate each decoded frame set. As used herein a “deserialization operation” refers to any type of operation that is executed when performing deserialization, where deserialization is a process of reconstructing original data objects based on a serialized version of the original data objects.

In general, the deserializer 330 can evaluate any amount and/or types of decoded metadata included in or otherwise associated with the decoded serialized frames to generate each decoded frame set. In particular, the deserializer 330 can evaluate any amount and/or types of decoded metadata included in the decoded serialized frames to determine the frame type of each of the decoded frames included in the decoded serialized frames and to establish correspondences between the decoded frames.

For explanatory purposes, FIG. 3 depicts and describes the functionality of the lossless alpha engine 350 and the rendering engine 360 in the context of generating the rendered frame 362 based on the current decoded frame set 340. The current decoded frame set 340 is a decoded frame set at a current point-in-time. As shown, the current decoded frame set 340 includes, without limitation, a decoded color frame 342, a decoded alpha frame 344, and a decoded alpha residual frame 346. The decoded alpha frame 344 corresponds to the decoded color frame 342, and the decoded alpha residual frame 346 corresponds to the decoded alpha frame 344.

As shown, the lossless alpha engine 350 generates a restored alpha frame 354 based on the decoded alpha frame 344 and the decoded alpha residual frame 346. More precisely, the lossless alpha engine 350 sets restored alpha values included in the restored alpha frame 354 equal to the pixel-wise summation of reconstructed alpha values included in the decoded alpha frame 344 and residual alpha values included in the decoded alpha residual frame 346. The computation for the restored alpha frame 354 can be expressed as: the restored alpha frame 354=the decoded alpha frame 344+the decoded alpha residual frame 346.

As shown, the rendering engine 360 generates the rendered frame 362 that includes any number and/or types of transparency-based visual effects based on the decoded color frame 342 and the restored alpha frame 354. In operation, the rendering engine 360 can perform any number and/or types of rendering operations on the decoded color frame 342 and the restored alpha frame 354 to generate the rendered frame 362. As used herein, a “rendering operation” refers to any type of operation that is executed when rendering, where rendering is a process of using decoded color frames, optionally any number and/or types of alpha data, and optionally any amount and/or types of other video and/or image data to generate a rendered frame that can be displayed for direct viewing. The rendering engine 360 stores the rendered frame 362 in the display buffer 198 for subsequent display by the endpoint device 180.

Note that the techniques described herein are illustrative rather than restrictive and can be altered without departing from the broader spirit and scope of the invention. Many modifications and variations on the functionality of the playback pipeline 190, the decoder 310, the deserializer 330, the lossless alpha engine 350, and the rendering engine 360 as described herein will be apparent to those of ordinary skill in the art without departing from the scope and spirit of the described embodiments.

Advantageously, because the playback pipeline 130 can determine decoded frame sets based on a single bitstream (e.g., the unified video bitstream 160), the playback pipeline 130 can more accurately compute rendered frames that include transparency-based visual effects relative to prior art techniques. Furthermore, unlike some prior art techniques, the playback pipeline 130 uses a single instance of a decoder to generate rendered frames that include transparency-based visual effects. Accordingly, with the disclosed techniques, some endpoint devices that were unable to perform the video processing techniques necessary to generate rendered frames with transparency-based visual effects based on multiple different bitstreams can effectively generate and playback such rendered frames.

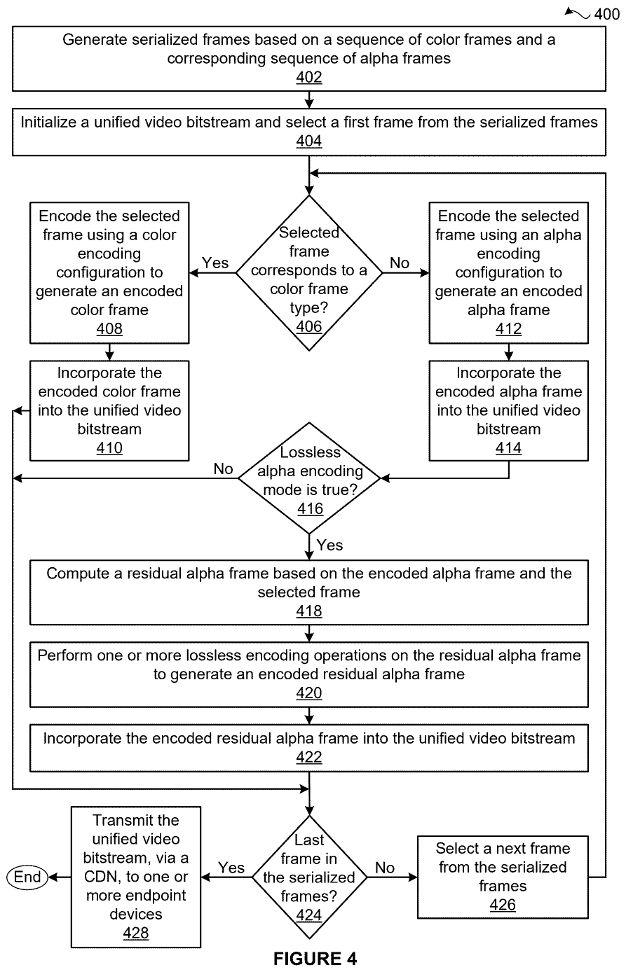

FIG. 4 is a flow diagram of method steps for encoding color frames and corresponding alpha frames to generate a unified video bitstream, according to various embodiments. Although the method steps are described with reference to the system of FIGS. 1 and 2, persons skilled in the art will understand that any system configured to implement the method steps, in any order, falls within the scope of the various embodiments.

As shown, a method 400 begins at step 402, where the serializer 130 generates serialized frames 138 based on a sequence of color frames and a corresponding sequence of alpha frames. At step 404, the video encoding application 140 initializes a unified video bitstream and selects a first frame from the serialized frames 138.

At step 406, the video encoding application 140 determines whether the selected frame corresponds to a color frame type. If, at step 406, the video encoding application 140 determines that the selected frame corresponds to the color frame type, then the method 400 proceeds to step 408. At step 408, the video encoding application 140 encodes the selected frame using color encoding configuration 142 to generate an encoded color frame. At step 410, the video encoding application 140 incorporates the encoded color frame into the unified video bitstream. The method 400 then proceeds directly to step 424.

If, however, at step 408, the video encoding application 140 determines that the selected frame does not correspond to the color frame type, then the method 400 proceeds directly to step 412. At step 412, the video encoding application 140 encodes the selected frame using alpha encoding configuration 144 to generate an encoded alpha frame. At step 414, the video encoding application 140 incorporates the encoded alpha frame into the unified video bitstream. At step 416, the video encoding application 140 determines whether lossless alpha encoding mode 146 is true. If, at step 416, the video encoding application 140 determines that the lossless alpha encoding mode 146 is not true, then the method 400 proceeds directly to step 424.

If, however, at step 416, the video encoding application 140 determines that the lossless alpha encoding mode 146 is true, then the method 400 proceeds to step 418. At step 418, the video encoding application 140 computes a residual alpha frame based on the encoded alpha frame and the selected frame. At step 420, the video encoding application 140 performs one or more lossless encoding operations on the residual alpha frame to generate an encoded residual alpha frame. At step 422, the video encoding application 140 incorporates the encoded residual alpha frame into the unified video bitstream.

At step 424, the video encoding application 140 determines whether the selected frame is the last frame in the serialized frames 138. If, at step 424, the video encoding application 140 determines that the selected frame is not the last frame in the serialized frames 138, then the method 400 proceeds to step 426. At step 426, the video encoding application 140 selects a next frame from the serialized frames 138. The method 400 then returns to step 406, where the video encoding application 140 determines whether the selected frame corresponds to a color frame type.

If, however, at step 424, the video encoding application 140 determines that the selected frame is the last frame in the serialized frames 138, then the method 400 proceeds directly to step 428. At step 428, the unified encoding pipeline 120 transmits the unified video bitstream, via the CDN 170, to one or more endpoint devices. The method 400 then terminates.

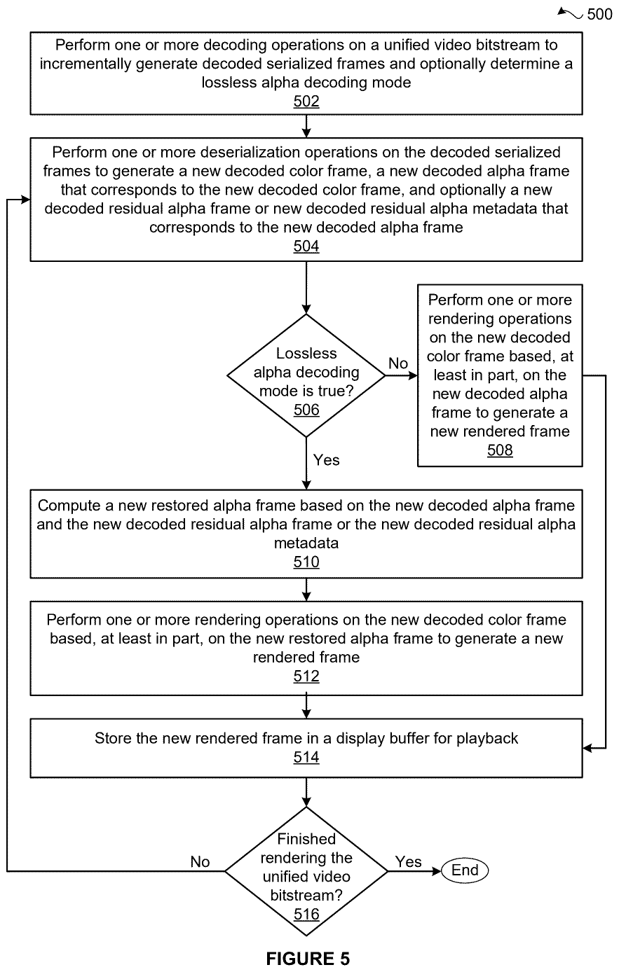

FIG. 5 is a flow diagram of method steps for decoding a unified video bitstream to generate rendered video content for playback, according to various embodiments. Although the method steps are described with reference to the system of FIGS. 1 and 3, persons skilled in the art will understand that any system configured to implement the method steps, in any order, falls within the scope of the various embodiments.

As shown, a method 500 begins at step 502, where the decoder 310 performs one or more decoding operations on a unified video bitstream to incrementally generate decoded serialized frames and optionally determine a lossless alpha decoding mode. At step 504, the deserializer 330 performs one or more deserialization operations on the decoded serialized frames to generate a new decoded color frame, a new decoded alpha frame that correspond to the new decoded color frame, and optionally a new decoded residual alpha frame or new decoded residual alpha metadata that corresponds to the new decoded alpha frame.

At step 506, the playback pipeline 190 determines whether the lossless alpha decoding mode is true. If, at step 506, the playback pipeline 190 determines that the lossless alpha decoding mode is not true, then the method 500 proceeds to step 508. At step 508, the rendering engine 360 performs one or more rendering operations on the new decoded color frame based, at least in part, on the new decoded alpha frame to generate a new rendered frame. The method 500 then proceeds directly to step 514.

If, however, at step 506, the playback pipeline 190 determines that the lossless alpha decoding mode is true, then the method 500 proceeds directly to step 510. At step 510, the lossless alpha engine 350 computes a new restored alpha frame based on the new decoded alpha frame and the new decoded residual alpha frame or the new decoded residual alpha metadata. At step 512, the rendering engine 360 performs one or more rendering operations on the new decoded color frame based, at least in part, on the new restored alpha frame to generate a new rendered frame.

At step 514, the rendering engine 360 stores the new rendered frame in display buffer 198 for playback. At step 516, the playback pipeline 190 determines whether the playback pipeline 190 has finished rendering the unified video bitstream. If, at step 516, the playback pipeline 190 determines that the playback pipeline 190 has not finished rendering the unified video bitstream, then the method 500 returns to step 504, where the deserializer 330 performs one or more deserialization operations on the decoded serialized frames to generate a new decoded color frame, a new decoded alpha frame that correspond to the new decoded color frame, and optionally a new decoded residual alpha frame or new decoded residual alpha metadata that corresponds to the new decoded alpha frame.

If, however, at step 516, the playback pipeline 190 determines that the playback pipeline 190 has finished rendering the unified video bitstream, then the method 500 terminates.

In sum, the disclosed techniques can be used to generate a unified video bitstream that enables endpoint devices to generate and playback rendered video content that includes transparency-based visual effects. In some embodiments, a unified encoding pipeline includes a serializer and a video encoding application. If a first bit depth associated with a sequence of alpha frames included in source video content is not equal to a second bit depth associated with a corresponding sequence of color frames included in the source video content, then the serializer converts the sequence of alpha frames from the first bit depth to the second bit depth. The serializer performs one or more serialization operations on the sequence of color frames and the sequence of alpha frames having the second bit depth to generate serialized frames. Frame numbers and/or other metadata associated with the serialized frames indicate whether each frame corresponds to a color frame type or an alpha frame type and establish a one-to-one correspondence between the color frames and the alpha frames. The video encoding application sequentially encodes each frame included in the serialized frames and any associated metadata to generate a unified video bitstream.

To encode a “current” frame included in the serialized frames, the video encoding application determines whether the current frame corresponds to the color frame type or the alpha frame type based on the frame number or other metadata associated with the current frame. If the video encoding application determines that the current frame corresponds to the color frame type, then the video encoding application encodes the current frame using a color encoding configuration and a majority of the reference frame slots included in a reference buffer to generate an encoded color frame. If, however, the video encoding application determines that the current frame corresponds to the alpha frame type, then the video encoding application encodes the current frame using an alpha frame configuration and the remainder of the reference frame slots included in the reference buffer to generate an encoded alpha frame. Notably, the alpha encoding configuration includes any number and/or types of modifications relative to the color encoding configuration to increase compression efficiency and/or encoding precision for alpha frames. Further, if the current frame corresponds to an alpha frame type and a lossless alpha encoding mode is true, then the video encoding application generates a residual alpha frame and optionally any amount of associated metadata based on the encoded alpha frame and the current frame. The video encoding application then encodes the residual alpha frame to generate an encoded residual alpha frame.

The unified encoding pipeline transmits, via a CDN, the unified video bitstream to any number of endpoint devices. Each endpoint device implements a playback pipeline that includes a decoder, a deserializer, a rendering engine, and optionally a lossless alpha engine. The decoder performs one or more decoding operations on the unified video stream to generate decoded serialized frames that include any amount and/or types of associated decoded metadata. If the playback pipeline includes a lossless alpha engine and the decoded serialized frames include decoded residual alpha frames, then the playback pipeline sets a lossless alpha decoding mode to true. Otherwise the lossless alpha decoding mode defaults to false.

The deserializer performs one or more deserialization operations on the serialized frames to sequentially generate decoded frame sets. Each decoded frame set includes a decoded color frame, a corresponding decoded alpha frame, and optionally a corresponding decoded residual alpha frame. If the lossless alpha decoding mode is true, then the lossless alpha engine computes a restored alpha frame based on the decoded alpha frame and the decoded residual alpha frame. The rendering engine then computes a rendered frame that can include any number and/or types of transparency-based visual effects based on the decoded color frame and the restored alpha frame. If, however, the lossless alpha decoding mode is false, then the rendering engine computes a rendered frame that can include any number and/or types of transparency-based visual effects based on the decoded color frame and the decoded alpha frame. As the rendering engine generates each rendered frame, the rendering engine stores the rendered frame in a display buffer for subsequent display by the endpoint device.

At least one technical advantage of the disclosed techniques relative to the prior art is that, with the disclosed techniques, endpoint devices can more accurately compute rendered frames that include transparency-based visual effects. In that regard, a unified video bitstream that includes encoded video frames, encoded alpha frames, and one or more synchronization mechanisms is generated and transmitted to any number of endpoint devices. Each endpoint device can use one of the synchronization mechanisms to compute each rendered frame based on a decoded color frame and a temporally-aligned decoded alpha frame. Another advantage of the disclosed techniques is that, unlike prior art techniques, with the disclosed techniques, an endpoint device does not need to decode multiple different bitstreams in order to generate and display rendered video content that includes transparency-based visual effects. Accordingly, with the disclosed techniques, endpoint devices that were unable to perform the video processing techniques necessary to generate rendered video content with transparency-based visual effects based on multiple different bitstreams can now effectively generate and playback such rendered video content. These technical advantages provide one or more technical advancements over prior art approaches.
1. In some embodiments, a computer-implemented method for generating unified video bitstreams comprises performing one or more serialization operations on a sequence of color frames and a sequence of alpha frames to generate a plurality of serialized frames; determining that a first frame included in the plurality of serialized frames corresponds to a color frame type; encoding the first frame to generate an encoded color frame; incorporating the encoded color frame into a first unified video bitstream; determining that a second frame included in the plurality of serialized frames corresponds to an alpha frame type; encoding the second frame to generate an encoded alpha frame; and incorporating the encoded alpha frame into the first unified video bitstream.
2. The computer-implemented method of clause 1, wherein performing the one or more serialization operations comprises interleaving the sequence of color frames with the sequence of alpha frames.
3. The computer-implemented method of clauses 1 or 2, further comprising, prior to performing the one or more serialization operations, converting an initial sequence of alpha frames from a first bit depth to a second bit depth that is associated with the sequence of color frames to generate the sequence of alpha frames.
4. The computer-implemented method of any of clauses 1-3, wherein performing the one or more serialization operations comprises assigning a first frame number that indicates the color frame type to the first frame and assigning a second frame number that indicates the alpha frame type to the second frame.
5. The computer-implemented method of any of clauses 1-4, wherein performing the one or more serialization operations comprises generating metadata indicating that the second frame corresponds to the first frame.
6. The computer-implemented method of any of clauses 1-5, wherein metadata associated with the second frame or a frame number associated with the second frame is evaluated to determine that the second frame corresponds to the alpha frame type.
7. The computer-implemented method of any of clauses 1-6, further comprising computing a residual alpha frame based on the encoded alpha frame and the second frame; performing one or more encoding operations on the residual alpha frame to generate an encoded residual alpha frame; and incorporating the encoded residual alpha frame into the first unified video bitstream.
8. The computer-implemented method of any of clauses 1-7, wherein the first frame is encoded based on a first reference frame count, and the second frame is encoded based on a second reference frame count that is lower than the first reference frame count.
9. The computer-implemented method of any of clauses 1-8, wherein a first quantization parameter value used to encode the first frame greater than a second quantization parameter value used to encode the second frame.
10. The computer-implemented method of any of clauses 1-8, wherein at least a first in-loop filter is disabled when encoding the first frame
11. In some embodiments, one or more non-transitory computer readable media include instructions that, when executed by one or more processors, cause the one or more processors to generate unified video bitstreams by performing the steps of performing one or more serialization operations on a sequence of color frames and a sequence of alpha frames to generate a plurality of serialized frames; determining that a first frame included in the plurality of serialized frames corresponds to a color frame type; encoding the first frame to generate an encoded color frame; incorporating the encoded color frame into a first unified video bitstream; determining that a second frame included in the plurality of serialized frames corresponds to an alpha frame type; encoding the second frame to generate an encoded alpha frame; and incorporating the encoded alpha frame into the first unified video bitstream.
12. The one or more non-transitory computer readable media of clause 11, wherein performing the one or more serialization operations comprises interpolating between two timestamps associated with the sequence of color frames to generate an interpolated timestamp; and assigning the interpolated timestamp to the second frame.
13. The one or more non-transitory computer readable media of clauses 11 or 12, further comprising, prior to performing the one or more serialization operations, converting an initial sequence of alpha frames from a first bit depth to a second bit depth that is associated with the sequence of color frames to generate the sequence of alpha frames.
14. The one or more non-transitory computer readable media of any of clauses 11-13, wherein performing the one or more serialization operations comprises generating metadata indicating that the first frame corresponds to the color frame type and that the second frame corresponds to the alpha frame type.
15. The one or more non-transitory computer readable media of any of clauses 11-14, wherein performing the one or more serialization operations comprises generating metadata indicating that the second frame corresponds to the first frame.
16. The one or more non-transitory computer readable media of any of clauses 11-15, wherein metadata associated with the second frame or a frame number associated with the second frame is evaluated to determine that the second frame corresponds to the alpha frame type.
17. The one or more non-transitory computer readable media of any of clauses 11-16, further comprising computing a residual alpha frame based on the encoded alpha frame and the second frame; performing one or more encoding operations on the residual alpha frame to generate encoded residual alpha metadata; and incorporating the encoded residual alpha metadata into the first unified video bitstream.
18. The one or more non-transitory computer readable media of any of clauses 11-17, wherein the first frame is encoded based on a first reference frame count, and the second frame is encoded based on a second reference frame count that is lower than the first reference frame count.
19. The one or more non-transitory computer readable media of any of clauses 11-18, wherein a first quantization parameter value used to encode the first frame greater than a second quantization parameter value used to encode the second frame.
20. In some embodiments, a system comprises one or more memories storing instructions and one or more processors coupled to the one or more memories that, when executing the instructions, perform the steps of performing one or more serialization operations on a sequence of color frames and a sequence of alpha frames to generate a plurality of serialized frames; determining that a first frame included in the plurality of serialized frames corresponds to a color frame type; encoding the first frame to generate an encoded color frame; incorporating the encoded color frame into a first unified video bitstream; determining that a second frame included in the plurality of serialized frames corresponds to an alpha frame type; encoding the second frame to generate an encoded alpha frame; and incorporating the encoded alpha frame into the first unified video bitstream.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating unified video bitstreams, the method comprising:
performing one or more serialization operations on a sequence of color frames and a sequence of alpha frames to generate a plurality of serialized frames;
determining that a first frame included in the plurality of serialized frames corresponds to a color frame type;
encoding the first frame to generate an encoded color frame;
incorporating the encoded color frame into a first unified video bitstream;
determining that a second frame included in the plurality of serialized frames corresponds to an alpha frame type;
encoding the second frame to generate an encoded alpha frame; and
incorporating the encoded alpha frame into the first unified video bitstream.

2. The computer-implemented method of claim 1, wherein performing the one or more serialization operations comprises interleaving the sequence of color frames with the sequence of alpha frames.

3. The computer-implemented method of claim 1, further comprising, prior to performing the one or more serialization operations, converting an initial sequence of alpha frames from a first bit depth to a second bit depth that is associated with the sequence of color frames to generate the sequence of alpha frames.

4. The computer-implemented method of claim 1, wherein performing the one or more serialization operations comprises assigning a first frame number that indicates the color frame type to the first frame and assigning a second frame number that indicates the alpha frame type to the second frame.

5. The computer-implemented method of claim 1, wherein performing the one or more serialization operations comprises generating metadata indicating that the second frame corresponds to the first frame.

6. The computer-implemented method of claim 1, wherein metadata associated with the second frame or a frame number associated with the second frame is evaluated to determine that the second frame corresponds to the alpha frame type.

7. The computer-implemented method of claim 1, further comprising:
computing a residual alpha frame based on the encoded alpha frame and the second frame;
performing one or more encoding operations on the residual alpha frame to generate an encoded residual alpha frame; and
incorporating the encoded residual alpha frame into the first unified video bitstream.

8. The computer-implemented method of claim 1, wherein the first frame is encoded based on a first reference frame count, and the second frame is encoded based on a second reference frame count that is lower than the first reference frame count.

9. The computer-implemented method of claim 1, wherein a first quantization parameter value used to encode the first frame greater than a second quantization parameter value used to encode the second frame.

10. The computer-implemented method of claim 1, wherein at least a first in-loop filter is disabled when encoding the first frame.

11. One or more non-transitory computer readable media including instructions that, when executed by one or more processors, cause the one or more processors to generate unified video bitstreams by performing the steps of:
performing one or more serialization operations on a sequence of color frames and a sequence of alpha frames to generate a plurality of serialized frames;
determining that a first frame included in the plurality of serialized frames corresponds to a color frame type;
encoding the first frame to generate an encoded color frame;
incorporating the encoded color frame into a first unified video bitstream;
determining that a second frame included in the plurality of serialized frames corresponds to an alpha frame type;
encoding the second frame to generate an encoded alpha frame; and
incorporating the encoded alpha frame into the first unified video bitstream.

12. The one or more non-transitory computer readable media of claim 11, wherein performing the one or more serialization operations comprises:
interpolating between two timestamps associated with the sequence of color frames to generate an interpolated timestamp; and
assigning the interpolated timestamp to the second frame.

13. The one or more non-transitory computer readable media of claim 11, further comprising, prior to performing the one or more serialization operations, converting an initial sequence of alpha frames from a first bit depth to a second bit depth that is associated with the sequence of color frames to generate the sequence of alpha frames.

14. The one or more non-transitory computer readable media of claim 11, wherein performing the one or more serialization operations comprises generating metadata indicating that the first frame corresponds to the color frame type and that the second frame corresponds to the alpha frame type.

15. The one or more non-transitory computer readable media of claim 11, wherein performing the one or more serialization operations comprises generating metadata indicating that the second frame corresponds to the first frame.

16. The one or more non-transitory computer readable media of claim 11, wherein metadata associated with the second frame or a frame number associated with the second frame is evaluated to determine that the second frame corresponds to the alpha frame type.

17. The one or more non-transitory computer readable media of claim 11, further comprising:
computing a residual alpha frame based on the encoded alpha frame and the second frame;
performing one or more encoding operations on the residual alpha frame to generate encoded residual alpha metadata; and
incorporating the encoded residual alpha metadata into the first unified video bitstream.

18. The one or more non-transitory computer readable media of claim 11, wherein the first frame is encoded based on a first reference frame count, and the second frame is encoded based on a second reference frame count that is lower than the first reference frame count.

19. The one or more non-transitory computer readable media of claim 11, wherein a first quantization parameter value used to encode the first frame greater than a second quantization parameter value used to encode the second frame.

20. A system comprising:
one or more memories storing instructions; and
one or more processors coupled to the one or more memories that, when executing the instructions, perform the steps of:
performing one or more serialization operations on a sequence of color frames and a sequence of alpha frames to generate a plurality of serialized frames;
determining that a first frame included in the plurality of serialized frames corresponds to a color frame type;
encoding the first frame to generate an encoded color frame;
incorporating the encoded color frame into a first unified video bitstream;
determining that a second frame included in the plurality of serialized frames corresponds to an alpha frame type;
encoding the second frame to generate an encoded alpha frame; and
incorporating the encoded alpha frame into the first unified video bitstream.
